(19) United States
(12) Patent Application Publication
(10) Pub. No.: US 2026/0046714 A1
(43) Pub. Date: Feb. 12, 2026

(54) MEASUREMENT AND MOBILITY PROCEDURE DUE TO DOPPLER ISSUE IN IoT NTN

(71) Applicant: Telefonaktiebolaget LM Ericsson (publ), Stockholm (SE)

(72) Inventors: Santhan Thangarasa, Vällingby (SE); Muhammad Ali Kazmi, Reston, VA (US); Ming Li, Stockholm (SE)

(21) Appl. No.: 19/102,143

(22) PCT Filed: Aug. 10, 2023
(86) PCT No.: PCT/SE2023/050804

§ 371 Date: Feb. 7, 2025

Related U.S. Application Data
(60) Provisional application No. 63/396,760, filed on Aug. 10, 2022.

(51) Int. Cl. H04W 36/00

(52) U.S. Cl. CPC H04W 36/0085; H04W 36/0061

(57) ABSTRACT

A method, network node and wireless device (WD) for measurement and mobility procedures due to doppler issues in an Internet of things (IoT) non-terrestrial network (NTN) are disclosed. According to one aspect, a method in a WD includes determining at least one neighbor cell and at least one frequency layer for which a measurement procedure is to be adapted due to Doppler shift. The method includes adapting the measurement procedure for the at least one neighbor cell and the at least one frequency layer, including at least one of deprioritizing, discarding, ignoring and skipping measurements on at least one of a neighbor cell of the determined at least one neighbor cell and a frequency layer of the determined at least one frequency layer.

### TECHNICAL FIELD

The present disclosure relates to wireless communications, and in particular, to measurement and mobility procedures due to doppler issues in an Internet of things (IoT) non-terrestrial network (NTN).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

In 3GPP, 5G systems (5GS) are a new generation's radio access technology intended to serve use cases such as enhanced mobile broadband (eMBB), ultra-reliable and low latency communication (URLLC), narrow band (NB)-IOT and machine type communications (mMTC). 5G includes the New Radio (NR) access stratum interface and the 5G Core Network (5GC). The NR physical and higher layers reuse parts of the LTE specification, and add needed components when motivated by new use cases. To benefit from the strong mobile ecosystem and economy of scale, a satellite network based on the terrestrial wireless access technologies that include LTE and NR, is being specified in the 3GPP standard.

### IoT NTN and NTN Characteristics

A satellite radio access network usually includes the following components:
A satellite that refers to a space-borne platform;
An earth-based gateway that connects the satellite to a base station or a core network, depending on the choice of architecture;
Feeder link that refers to the link between a gateway and a satellite; and
Access link, or service link, that refers to the link between a satellite and a WD.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes;
MEO: typical heights ranging from 5,000-25,000 km, with orbital periods ranging from 3-15 hours; and
GEO: height at about 35,786 km, with an orbital period of 24 hours.

Two basic architectures may be distinguished for satellite communication networks, depending on the functionality of the satellites in the system. A transparent payload (also referred to as bent pipe architecture) and a regenerative payload. In the bent pipe architecture, the satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the WD. In the regenerative payload architecture, the satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP Technical Release 17 (3GPP Rel-17), only the transparent payload architecture is considered.

A satellite network or satellite based mobile network may also be called a non-terrestrial network (NTN). On the other hand, a mobile network with base stations in the group may also be called a terrestrial network (TN) or non-NTN network. A satellite within an NTN may be called an NTN node, NTN satellite or simply a satellite.

FIG. 1 shows an example architecture of a satellite network with bent pipe transponders (i.e., the transparent payload architecture).

A communication satellite typically generates several beams over a given area. The footprint of a beam is usually an elliptic shape, which has traditionally been considered as a cell. However, cells that include the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

In a LEO or MEO communication system, a large number of satellites deployed over a range of orbits are required to provide continuous coverage across the full globe. Launching a mega satellite constellation is both an expensive and time-consuming procedure. It is therefore expected that all LEO and MEO satellite constellations for some time will only provide partial earth-coverage. In case of some constellations dedicated to massive IoT services with relaxed latency requirements, it may not even be necessary to support full earth-coverage. It may be sufficient to provide occasional or periodic coverage according to the orbital period of the constellation.

A 3GPP device in RRC_IDLE or RRC_INACTIVE state is required to perform number of procedures including measurements for mobility purposes, paging monitoring, logging measurement results, tracking area update, and search for a new public land mobile network (PLMN) to mention a few. These procedures will consume power in devices, and a general trend in 3GPP has been to allow for relaxation of these procedures to prolong device battery life. This trend has been especially pronounced for IoT devices supported by reduced capability (redcap), NB-IoT and LTE-M.

Propagation delay is an important aspect of satellite communications that is different from the delay expected in a terrestrial mobile system. For a bent pipe satellite network, the round-trip delay may, depending on the orbit height, range from tens of milliseconds (ms) in the case of LEO satellites to several hundreds of ms for GEO satellites. As a comparison, the round-trip delays in terrestrial cellular networks are typically below 1 ms.

The distance between the WD and a satellite may vary significantly, depending on the position of the satellite and thus the elevation angle F seen by the WD. Assuming circular orbits, the minimum distance is realized when the satellite is directly above the WD (ε=90°), and the maximum distance when the satellite is at the smallest possible elevation angle. Table 1 shows the distances between satellite and WD for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | | | One-way | | Propagation |
|---|---|---|---|---|---|---|
| Orbital | Elevation | Distance | | propagation | | delay |
| height | angle | UE <-> satellite | | delay | | difference |
| 600 km | 90° | 600 | km | 2.0 | ms | — |
| | 30° | 1075 | km | 3.6 | ms | 1.6 ms |
| | 10° | 1932 | km | 6.4 | ms | 4.4 ms |
| 1200 km | 90° | 1200 | km | 4.0 | ms | — |
| | 30° | 1999 | km | 6.7 | ms | 2.7 ms |
| | 10° | 3131 | km | 10.4 | ms | 6.4 ms |
| 35786 km | 90° | 35786 | km | 119.4 | ms | — |
| | 30° | 38609 | km | 128.8 | ms | 9.4 ms |
| | 10° | 40581 | km | 135.4 | ms | 16.0 ms |

The propagation delay may also be highly variable due to the high velocity of the LEO and MEO satellites and change in the order of 10-100 μs every second, depending on the orbit altitude and satellite velocity.

### Ephemeris Data

In 3GPP Technical Report (TR) 38.821, it has been considered that ephemeris data should be provided to the WD, for example to assist with pointing a directional antenna (or an antenna beam) towards the satellite. A WD knowing its own position, because of global navigation satellite system (GNSS) support, may also use the ephemeris data to calculate correct timing related and/or frequency drifts, e.g., Timing Advance (TA) and Doppler shift. The contents of the ephemeris data and the procedures on how to provide and update such data have not yet been studied in detail.

A satellite orbit may be fully described using 6 parameters. Exactly which set of parameters is used may be decided by the user; many different representations are possible. For example, a choice of parameters used often in astronomy is the set (a, ε, i, Ω, ω, t). Here, the semi-major axis a and the eccentricity F describe the shape and size of the orbit ellipse; the inclination i, the right ascension of the ascending node Ω, and the argument of periapsis ω determine its position in space, and the epoch t determines a reference time (e.g., the time when the satellites moves through periapsis). The set of these parameters is illustrated in FIG. 2.

A two-line element set (TLE) is a data format encoding a list of orbital elements of an Earth-orbiting object for a given point in time, the epoch. As an example of a different parametrization, TLEs use mean motion n and mean anomaly M instead of a and t.

A completely different set of parameters is the position and velocity vector (x, y, z, vₓ, v_{y}, v_{z}) of a satellite. These are sometimes called orbital state vectors. They may be derived from the orbital elements and vice versa since the information they contain is equivalent. All these formulations (and many others) are possible choices for the format of ephemeris data to be used in NTN.

Additionally, the ephemeris data may be accompanied with information on possible coverage area, or timing information when the satellite is going to serve a certain geographical area on Earth.

### IoT

### NB-IoT Operation

Narrow Band Internet of Things (NB-IoT) addresses improved indoor coverage, support for massive numbers of low throughput devices, low delay sensitivity, ultra-low device cost, low device power consumption and (optimized) network architecture. The NB-IoT carrier BW (Bw2) is 200 KHz.

NB-IoT supports 3 different deployment scenarios or mode of operations:
1) ‘Stand-alone operation’ utilizing for example the spectrum currently being used by Global System for Mobile (GSM) Edge Radio Access Network (GERAN) systems as a replacement of one or more GSM carriers. In principle, it operates on any carrier frequency which is neither within the carrier of another system nor within the guard band of another system's operating carrier. The other system may be another NB-IoT operation or any other radio access technology (RAT), e.g., LTE.
2) ‘Guard band operation’ utilizing the unused resource blocks within an LTE carrier's guard-band. The term guard band may also interchangeably be called a guard bandwidth. As an example in case of LTE BW of 20 MHz (i.e., Bw1=20 MHz or 100 RBs), the guard band operation of NB-IoT may be placed anywhere outside the central 18 MHz but within 20 MHz LTE BW.
3) ‘In-band operation’ utilizing resource blocks within a normal LTE carrier. The in-band operation may also interchangeably be called in-bandwidth operation. More generally the operation of one RAT within the BW of another RAT is also called an in-band operation. As an example in a LTE BW of 50 resource blocks (RBs) (i.e., Bw1=10 MHz or 50 RBs), NB-IoT operation over one resource block (RB) within the 50 RBs is called in-band operation.

### Anchor Carrier and Non-Anchor Carrier in NB-IoT

In NB-IoT anchor and non-anchor carriers are defined. For an anchor carrier, the WD assumes that anchor specific signals including narrowband primary synchronization signal (NPSS)/narrowband secondary synchronization signals (NSSS)/narrowband physical broadcast channel (NPBCH)/system information block narrowband (SIB-NB) are transmitted on the downlink. For a non-anchor carrier, the WD does not assume that NPSS/NSSS/NPBCH/SIB-NB are transmitted on the downlink. The anchor carrier is transmitted on at least subframes #0, #4, #5 in every frame and subframe #9 in every other frame. Additional downlink (DL) subframes in a frame may also be configured on anchor carrier of means of a DL bit map. The anchor carriers transmitting NPBCH/SIB-NB contains narrowband reference signals (NRS). The non-anchor carrier contains NRS during certain occasions and WD specific signals such as narrowband physical downlink control channel (NPDCCH) and narrowband physical downlink shared channel (NPDSCH). NRS, NPDCCH and NPDSCH are also transmitted on an anchor carrier. The resources for non-anchor carrier are configured by the network node. The non-anchor carrier may be transmitted in any subframe as indicated by a DL bit map. For example, the eNB signals a DL bit map of DL subframes using RRC message (DL-Bitmap-NB) which are configured on a non-anchor carrier. The anchor carrier and/or non-anchor carrier may typically be operated by the same network node, e.g., by the serving cell. But the anchor carrier and/or non-anchor carrier may also be operated by different network nodes.

### MTC

The machine-to-machine (M2M) communication (or machine type communication (MTC)) is used for establishing communication between machines and between machines and humans. The communication may include exchange of data, signaling, measurement data, configuration information etc. The device size may vary from that of a wallet to that of a base station. The M2M devices are quite often used for applications like sensing environmental conditions (e.g., temperature reading), metering or measurement (e.g., electricity usage etc.), fault finding or error detection, etc. In these applications the M2M devices are very seldom active over a consecutive duration depending upon the type of service, e.g., about 200 ms once every 2 seconds, about 500 ms every 60 minutes, etc. The M2M device may also do measurement on other frequencies or other RATs.

The MTC device is expected to be of low cost and low complexity. A low complexity WD for M2M operation may implement one or more low cost features like, smaller downlink and uplink maximum transport block size (e.g., 1000 bits) and/or reduced downlink channel bandwidth of 1.4 MHz for data channel (e.g., PDSCH). A low cost WD may also include of a half-duplex frequency division duplex (HD-FDD) and one or more of the following additional features, single receiver (1 Rx) at the WD, smaller downlink and/or uplink maximum transport block size (e.g., 1000 bits) and reduced downlink channel bandwidth of 1.4 MHz for data channel. The low cost WD may also be called a low complexity WD.

eMTC

The eMTC features specified in 3GPP specifications include a low-complexity user equipment (UE) category called WD category M1 (or Cat-M1 for short) and coverage enhancement techniques (CE modes A and B) that may be used together with WD category M1 or any other LTE WD category.

All eMTC features (both Cat-M1 and E modes A and B) operate using a reduced maximum channel bandwidth compared to normal LTE. The maximum channel bandwidth in eMTC is 1.4 MHz, whereas it is up to 20 MHz in normal LTE. The eMTC WDs are still able to operate within the larger LTE system bandwidth without problem. The main difference compared to normal LTE WDs is that the eMTCs may only be scheduled with 6 physical resource blocks (PRBs) à 180 kHz at a time.

In CE modes A and B, the coverage of physical channels is enhanced through various coverage enhancement techniques, the most important being repetition or retransmission. In its simplest form, this means that the 1-ms subframe to be transmitted is repeated a number of times, e.g., just a few times if a small coverage enhancement is needed or hundreds or thousands of times if a large coverage enhancement is needed.

NB-IoT

The objective of Narrow Band Internet of Things (NB-IoT) is to specify a radio access for cellular Internet of things (IoT), based to a great extent on a non-backward-compatible variant of Evolved Universal Terrestrial Access (E-UTRA), that addresses improved indoor coverage, support for massive number of low throughput devices, low delay sensitivity, ultra-low device cost, low device power consumption and (optimized) network architecture. The NB-IoT carrier BW (Bw2) is 200 KHz. Examples of operating bandwidth (Bw1) of LTE are 1.4 MHz, 3 MHz, 5 MHz, 10 MHz, 15 MHz, 20 MHz etc.

In NB-IoT the downlink transmission is based on orthogonal frequency division multiplexing (OFDM) with 15 kHz subcarrier spacing for all the scenarios: standalone, guard-band, and in-band.
For UL transmission, both multi-tone transmissions based on single carrier frequency division multiple access (SC-FDMA), and single tone transmission are supported.

This means that the physical waveforms for NB-IoT in the downlink, and also partly in the uplink, are similar to legacy LTE.

In the downlink design, NB-IoT supports both master information broadcast (MIB) and system information broadcast which are carried by different physical channels. For in-band operation, it is possible for a NB-IoT WD to decode NB-PBCH without knowing the legacy physical resource block (PRB) index. NB-IoT supports both downlink physical control channel (NB-PDCCH, or NB-M-PDCCH) and downlink physical shared channel (PDSCH). The operation mode of NB-IoT must be indicated to the WD. Current 3GPP specifications have considered indication by means of NB-SSS, NB-MIB or perhaps other downlink signals.

At the moment, reference signals used in NB-IoT have not been decided. However, it is expected that the general design principle will follow that of legacy LTE. Downlink synchronization signals will most likely consist of a primary synchronization signal (NB-PSS) and a secondary synchronization signal (NB-SSS).

The following may be considered as main challenges that need to be addressed in IoT NTN: moving satellites (resulting in moving cells or switching cells) and long propagation delays.

Moving satellites (resulting in moving or switching cells): The default assumption in terrestrial network design, e.g., NR or LTE, is that cells are stationary. This is not the case in an NTN, especially when LEO satellites are considered. An LEO satellite may be visible to a WD on the ground only for a few seconds or minutes. There are two different options for LEO deployment. In the first option, the beam/cell coverage is fixed with respect to a geographical location with earth-fixed beams, i.e., steerable beams from satellites ensure that a certain beam covers the same geographical area even as the satellite moves in relation to the surface of the earth. On the other hand in the second option, with moving beams, an LEO satellite has fixed antenna pointing direction in relation to the earth's surface, e.g., perpendicular to the earth's surface, and thus cell/beam coverage sweeps the earth as the satellite moves. In that case, the spotbeam, which is serving the WD, may switch every few seconds.

The propagation delays in terrestrial mobile systems are usually less than 1 millisecond. In contrast, the propagation delays in an NTN may be much longer, ranging from several milliseconds (LEO) to hundreds of milliseconds (GEO) depending on the altitudes of the spaceborne or airborne platforms deployed in the IoT NTN.

In 3GPP Technical Release 18 (3GPP Rel-18), there are two work items on IoT NTN: RP-221556 (NB-IoT/eMTC core & performance requirements for NTN) and RP-221806 (IoT NTN (Non-Terrestrial Networks) enhancements).

According to objectives in RP-221556 the following aspects should be considered:

Objective of Core part WI
The objective of this Work Item is to specify RF and RRM requirements for NB-IoT and eMTC operation over NTN functionality defined in the Rel-17 LTE_NBIOT_eMTC_NTN work item, covering the following aspects:
   1) Specification of RF requirements for Satellite Access Node (SAN) and WD including the following [RAN4]:
      Specification of a 200 kHz channel raster in bands where this is feasible.
      In bands where it is not feasible to define a 200 kHz channel raster, the specification of a 100 kHz channel raster to be used in conjunction with signaling of the “part-of EARFCN” indication on MIB, with multiple EARFCN hypotheses.
      Verification of co-existence of IoT NTN with TN, re-using or extrapolating from existing coexistence results (from NR NTN or other) where appropriate, and considering additional simulations as necessary.
      Leveraging the studies and requirements (where applicable) of NTN NR bands n256 and n255 (and any relevant E-UTRA bands), specify the following new FDD frequency bands for NB-IoT/eMTC NTN operation:
         S-band (1980-2010 MHz in UL, and 2170-2200 MHz in DL)
         L band (1626.5 MHz-1660.5 MHz in UL, and 1525 MHz-1559 MHz in DL)

Doppler frequency in IoT NTN may be very large depending on the satellite deployment scenario. The Doppler frequencies corresponding to different satellite deployment scenario are listed below in Table 1 from 3GPP Technical Report (TR) 38.811 v15.4.0. The maximal Doppler shift is 48 KHz in LEO case. The Doppler frequency is therefore a much more critical issue compared to legacy TN systems.

### TR 38.811 v15.4.0

TABLE 1
from TR 38.811 v15.4.0: Summary of Doppler shift
and shift variation for different altitudes

| | | | | Max Doppler | | |
|---|---|---|---|---|---|---|
| Frequency | | | Relative | shift | | |
| (GHz) | Max Doppler | | Doppler | variation | | |
| 2 | +/−48 | kHz | 0.0024% | −544 | Hz/s | LEO at 600 |
| 20 | +/−480 | kHz | 0.0024% | −5.44 | kHz/s | km altitude |
| 30 | +/−720 | kHz | 0.0024% | −8.16 | kHz/s | |
| 2 | +/−40 | kHz | 0.002% | −180 | Hz/s | LEO at 1500 |
| 20 | +/−400 | kHz | 0.002% | −1.8 | kHz/s | km altitude |
| 30 | +/−600 | kHz | 0.002% | −2.7 | kHz/s | |
| 2 | +/−15 | kHz | 0.00075% | −6 | Hz/s | MEO at |
| 20 | +/−150 | kHz | 0.00075% | −60 | Hz/s | 10000 km |
| 30 | +/−225 | kHz | 0.00075% | −90 | Hz/s | altitude |

Regarding Doppler shift characteristics in IoT NTN, scenarios demonstrated in FIGS. 3 and 4 show how Doppler shift impacts IoT NTN.

In one example, a center frequency of the DL carrier from serving cell through Satellite1 is f1 and the bandwidth is BW1. The center frequency of the DL carrier from neighbor cell through Satellite2 is f2 and bandwidth is BW2. Through proper network configurations, êf1−f2ê≥(BW1+BW2)/2, e.g., the two carriers do not overlap or collide in frequency domain.

Referring now to FIG. 3, assume that Doppler shift on the link between WD and satellite1 is increasing and that Doppler shift on the link between WD and satellite2 is decreasing, e.g., the two satellites are moving in different directions. Accordingly, satellite1's Doppler shift at WD's side is f1−fd1, and satellite2's Doppler shift at WD's side is f2+fd2, where −fd1 and fd2 are the Doppler shift on f1 and f2. In other words, the WD receives a carrier at frequency: f1−fd1 and a carrier at frequency: f2+fd2 simultaneously, and the carrier at frequency f2+d2 is regarded as interference from the perspective of the WD.

Depending on the network configuration, BW1 and BW2 may collide (collision range is D_ds) fully or partially with respect to certain conditions including bandwidth, carrier frequency and Doppler shift, e.g.:

{(f1−fd1)−(f2+fd2)}≤(BW1+BW2)/2

In this case, partial or full collision between a received signal from satellite 1 at frequency f1 and interference from satellite 2 at f2 introduces significant signal to interference plus noise ratio (SINR) degradation at the WD when receiving from satellite 1 at frequency f1, and same to receiving from satellite 2 at frequency 2. This degradation becomes worse in multi-satellites scenario.

Regarding IoT NTN characteristics, e.g., 100/200 KHz channel raster and 200 KHz BW, if fd1=fd2=48 KHz, the guard band between two carriers should be at least 2*48=96 KHz to avoid the overlapping mentioned above. Possible legacy methods to mitigate Doppler shift issue are difficult to apply in IoT NTN, e.g.:
Wider Guard band between f1 and f2. The required guard band needs to cover all satellite carrier frequencies and maximal Doppler shift range. Also, the spectrum allocated to the operator may be limited. Therefore, using the guard band between the NB-IoT carrier may waste the spectrum; and
Advanced receiver processing, e.g., interference rejection combining (IRC) receiving, successive interference cancellation (SIC) receiving. This is not feasible due because the IoT WD is equipped with a single antenna and the advance receiver is expensive and increases power consumption draining the WD battery.

In another example, the center frequency of a DL carrier from a serving cell through Satellite1 is f1 and the bandwidth is BW1, the center frequency of the DL carrier from a neighbor cell through Satellite2 is f1 and the bandwidth is BW2.

Referring to FIG. 4, assume that the Doppler shift on link between the WD and satellite1 is increasing and that the Doppler shift on link between the WD and satellite2 is decreasing, e.g., the two satellites are moving in different directions. Accordingly, satellite1's Doppler shift at the WD is f1-fd1, satellite2's Doppler shift at the WD is f1+fd2, where −fd1 and fd2 are the Doppler shift at frequencies f1 and f2, respectively. As result, the WD receives the carrier at frequency: f1-fd1 and the carrier at frequency f1+fd2, simultaneously.

This implies that, if the WD wants to detect and measure on the serving cell and the neighbor cells on the same frequency, the WD may have to retune radio circuit, which relies on a collision range between the two carriers, D_ds, to measure the intra-frequency neighbor cell at frequency f1. In other words, the WD is not able to measure intra-frequency cells simultaneously because of Doppler shift. Also, different neighbor cells may have nonnegligible Doppler shift relative to each other.

### SUMMARY

Some embodiments advantageously provide methods, systems, and apparatuses for measurement and mobility procedures due to doppler issues in an Internet of things (IoT) non-terrestrial network (NTN).

Some embodiments provide methods for the WD in an NTN (e.g., WD served by an NTN node) to adaptively adjust cell changes (e.g., conditional cell change, conditional handover (CHO), cell reselection, cell selection, etc.) and measurement procedures (e.g., measurement rate, number, periodicity, duration, total number of carriers/frequencies/cells/satellites to be measured, etc.) based on assistance information related to Doppler shift introduced by moving satellites.

In some embodiments, the Doppler shift information (DSI) for signals operating between the WD and one or more cells on a carrier frequency is estimated or determined by a network node serving the WD by, for example, measurements on signals.

In some embodiments, the Doppler shift information (DSI) for signals operating between the WD and one or more cells on a carrier frequency is estimated or determined by the WD (e.g., by measurements on signals) and is further transmitted to a network node, e.g., to the serving cell.

In some embodiments, a method in a WD includes a WD deprioritizing, discarding, ignoring or skipping some neighbor cell measurements, and adapting, based on one or more rules, a measurement procedure for measurements performed on one or more neighbor cells. The rules for adaptation of measurement procedure may be predefined or configured by the network, with respect to Doppler shift.

In some embodiments, the network node (e.g., IoT NTN network node) informs the identifiers (e.g., cell ID or information about frequency layers (e.g., absolute radio frequency channel number (ARFCN), Evolved-ARFCN, NR-ARFCN, etc.)) of neighbor cells which may not be measured and corresponding Doppler shift information. This information may include a starting and ending time for ignoring measurements on those cells, and may be signaled to the WD by the network node on radio resource control (RRC) signaling, downlink control information (DCI) or medium access control (MAC) control element (CE). Based on the received signaling, the WD may perform one or more actions related to the measurements which includes skipping, discarding or deprioritizing the measurements on neighbor cells explicitly signaled by the network and recovering measurements on the neighbor cells, adaptively, or upon signaling by the network node.
One example rule is that the WD deprioritizes, ignores or skips measurements on neighbor cells explicitly signaled by network node.
Another example of the rule is that the WD deprioritizes, ignores or skips measurements on frequency layers explicitly signaled by network node.
Another example of the rule is that the WD allows longer measurement delays on neighbor cells explicit signaled by network node.
Another example of the rule is that the WD allows longer measurement delays on frequency layers explicitly signaled by network node.

One aspect or example of the method of the first embodiment is that the network node informs the identifiers (e.g., cell ID or information about frequency layers (e.g., ARFCN, EARFCN, NR-ARFCN etc.)) of neighbor cells which may be measured prioritized, starting/ending time of measurement prioritization on those cells to the WD by signaling on RRC, DCI or MAC-CE. After the WD receives the signaling, the WD may perform measurements procedure on neighbor cells explicitly signaled by network as a matter of priority and optionally recover other normal measurements without priority adaptively or upon signaling by network node.

Another example of the embodiment is that the WD detects and determines the identifiers (e.g., cell ID or frequency layers) of neighbor cells whose corresponding DSI fulfills one or more criteria pre-defined or configured by network node. Accordingly, the WD may perform measurements procedure skipping those neighbor cells, and optionally recover measurement on them adaptively.
One example of the rules is that the WD deprioritizes, ignores or skips measurements on neighbor cells provided that DSI fulfills one or more criteria.
Another example of the rule is that the WD deprioritizes, ignores or skips measurements on frequency layers provided that DSI fulfills one or more criteria.
Another example of the rules is that the WD allows longer measurement delays on neighbor cells provided that DSI fulfills one or more criteria.
Another example of the rules is that the WD allows longer measurement delays on frequency layers provided that DSI fulfills one or more criteria.

Alternatively, the WD detects and determines the identities (e.g., cell ID or frequency layers) of neighbor cells, e.g., whose corresponding DSI doesn't fulfill one or more criteria pre-defined or configured by network node. which may be measured prioritized, starting/ending time of measurement prioritization on those cells. Accordingly, the WD may perform measurements procedure on explicit neighbor cells as a matter of priority and optionally recover normal measurement without priority adaptively.

According to a second embodiment a method in a the WD includes determining that the WD starts searching neighbor cells for cell reselection and performs cell reselection subsequently based on one or more rules which may be predefined or configured by network, with respect to Doppler shift adaptively.

In one example of the rule of the embodiment is that the WD's starting search on neighbor cells is determined by DSI only or together with signal power level or signal quality relevant criteria, e.g., R-criteria in [2], provided that DSI fulfills one or more criteria.

Another example of embodiment is that the WD's starting cell selection after failing to find suitable cells is determined by DSI only or together with pre-defined time period.

According to a third embodiment a method in a the WD includes determining that requirements for detection and measurements on one or more intra-frequency cells and/or inter-frequency cells are applied or not applied in accordance with one or more rules. The rules for adaptive measurement procedure may be predefined or configured by network, with respect to Doppler shift.

One example of the rules is that detection and measurements on intra-frequency cells don't apply provided DSI fulfills one or more criteria. In this case, the WD is not required to meet any requirements.

Another example of the rules is that detection and measurements on intra-frequency cells follow detection and measurements requirements for inter-frequency cells provided DSI fulfills one or more criteria.

Another example of the rules is that intra-frequency neighbor cells detected and measured by the WD, provided that DSI fulfills one or more criteria, are counted into inter-frequency carriers indicated by the serving cell. In other words, Doppler shifted intra-frequencies are counted into inter-frequency carriers in detection and measurements on neighbor cells.

Another example of the rules is that detection and measurements on intra-frequency cells, which DSI fulfills one or more criteria, follow particular specified measurement requirements.

Some embodiments include methods which enhance measurements and cell change for the WD in IoT NTN (e.g., the WD served by IoT NTN node) based on Doppler assistance information.

According to one aspect, a method in a wireless device, WD, configured to communicate with a network node in a non-terrestrial network, NTN, is provided. The method includes determining at least one neighbor cell and at least one frequency layer for which a measurement procedure is to be adapted due to Doppler shift. The method includes adapting the measurement procedure for the at least one neighbor cell and the at least one frequency layer. Adapting the measurement procedure includes at least one of deprioritizing, discarding, ignoring and skipping measurements on at least one of a neighbor cell of the determined at least one neighbor cell and a frequency layer of the determined at least one frequency layer.

According to this aspect, in some embodiments, the measurement procedure is adapted according to at least one rule that is predefined or configured by the network node. In some embodiments, the at least one rule indicates the neighbor cell of the determined at least one neighbor cell for which a measurement is to be deprioritized, discarded, ignored or skipped. In some embodiments, the at least one rule indicates a frequency layer of the determined at least one frequency layer for which a measurement is to be deprioritized, discarded, ignored or skipped. In some embodiments, the at least one rule indicates a neighbor cell of the determined at least one neighbor cell for which additional measurement delays are allowed. In some embodiments, the at least one rule indicates a frequency layer of the determined at least one frequency layer for which additional measurement delays are allowed. In some embodiments, adapting the measurement procedure is based at least in part on whether Doppler shift information for a neighbor cell of the determined at least one neighbor cell fulfills criteria that is predefined or configured by the network node. In some embodiments, adapting the measurement procedure is based at least in part on whether Doppler shift information for a frequency layer of the determined at least one frequency layer fulfills criteria that is predefined or configured by the network node. In some embodiments, the method includes determining the Doppler shift information at the WD based at least in part on position information of at least one NTN node. In some embodiments, at least one of the determined at least one neighbor cell and the determined at least one frequency layer for which the measurement procedure is adapted are served by an NTN, node.

According to another aspect, a wireless device, WD, configured to communicate with a network node in a non-terrestrial network, NTN, is provided. The WD includes processing circuitry configured to: determine at least one neighbor cell and at least one frequency layer for which a measurement procedure is to be adapted due to Doppler shift; and adapt the measurement procedure for the at least one neighbor cell and the at least one frequency layer. Adapting the measurement procedure includes at least one of deprioritizing, discarding, ignoring and skipping measurements on at least one of a neighbor cell of the determined at least one neighbor cell and a frequency layer of the determined at least one frequency layer.

According to this aspect, in some embodiments, the measurement procedure is adapted according to at least one rule that is predefined or configured by the network node. In some embodiments, the at least one rule indicates the neighbor cell of the determined at least one neighbor cell for which a measurement is to be deprioritized, discarded, ignored or skipped. In some embodiments, the at least one rule indicates a frequency layer of the determined at least one frequency layer for which a measurement is to be deprioritized, discarded, ignored or skipped. In some embodiments, the at least one rule indicates a neighbor cell of the determined at least one neighbor cell for which additional measurement delays are allowed. In some embodiments, the at least one rule indicates a frequency layer of the determined at least one frequency layer for which additional measurement delays are allowed. In some embodiments, adapting the measurement procedure is based at least in part on whether Doppler shift information for a neighbor cell of the determined at least one neighbor cell fulfills criteria that is predefined or configured by the network node. In some embodiments, adapting the measurement procedure is based at least in part on whether Doppler shift information for a frequency layer of the determined at least one frequency layer fulfills criteria that is predefined or configured by the network node. In some embodiments, the processing circuitry is further configured to determine the Doppler shift information based at least in part on position information of at least one NTN node. In some embodiments, at least one of the determined at least one neighbor cell and the determined at least one frequency layer for which the measurement procedure is adapted are served by an NTN, node.

According to yet another aspect, a method in a network node configured to communicate with a wireless device, WD, in a non-terrestrial network, NTN, is provided. The method includes: transmitting to the WD an indication of at least one neighbor cell and at least one frequency layer for which a measurement procedure is to be adapted due to Doppler shift; and configuring the WD to adapt the measurement procedure performed by the WD. Configuring the WD to adapt the measurement procedure includes configuring an instruction to at least one of deprioritize, discard, ignore and skip measurements on at least one of a neighbor cell of the indicated at least one neighbor cell and a frequency layer of the indicated at least one frequency layer.

According to this aspect, in some embodiments, the measurement procedure is adapted according to at least one rule that is predefined or configured by the network node. In some embodiments, the at least one rule indicates a neighbor cell of the indicated at least one neighbor cell for which a measurement is to be deprioritized, discarded, ignored or skipped. In some embodiments, the at least one rule indicates a frequency layer of the indicated at least one frequency layer for which a measurement is to be deprioritized, discarded, ignored or skipped. In some embodiments, the at least one rule indicates a neighbor cell of the indicated at least one neighbor cell for which additional measurement delays are allowed. In some embodiments, the at least one rule indicates a frequency layer of the indicated at least one frequency layer for which additional measurement delays are allowed. In some embodiments, the method includes transmitting criteria to enable the WD to determine whether Doppler shift information for a neighbor cell of the indicated at least one neighbor cell fulfills the criteria. In some embodiments, the method includes transmitting criteria to enable the WD to determine whether Doppler shift information for a frequency layer of the indicated at least one frequency layer fulfills the criteria. In some embodiments, the method includes transmitting the Doppler shift information to the WD, the Doppler shift information being based at least in part on position information of at least one NTN node. In some embodiments, at least one of the indicated at least one neighbor cell and the indicated at least one frequency layer for which the measurement procedure is adapted are served by an NTN, node.

According to another aspect, a network node configured to communicate with a wireless device, WD, in a non-terrestrial network, NTN, is provided. The network node includes a radio interface configured to transmit to the WD an indication of at least one neighbor cell and at least one frequency layer for which a measurement procedure is to be adapted due to Doppler shift; and processing circuitry in communication with the radio interface and configured to configure the WD to adapt the measurement procedure performed by the WD. Configuring the WD to adapt the measurement procedure includes configuring an instruction to at least one of deprioritize, discard, ignore and skip measurements on at least one of a neighbor cell of the indicated at least one neighbor cell and a frequency layer of the indicated at least one frequency layer.

According to this aspect, in some embodiments, the measurement procedure is adapted according to at least one rule that is predefined or configured by the network node. In some embodiments, the at least one rule indicates a neighbor cell of the indicated at least one neighbor cell for which a measurement is to be deprioritized, discarded, ignored or skipped. In some embodiments, the at least one rule indicates a frequency layer of the indicated at least one frequency layer for which a measurement is to be deprioritized, discarded, ignored or skipped. In some embodiments, the at least one rule indicates a neighbor cell of the indicated at least one neighbor cell for which additional measurement delays are allowed. In some embodiments, the at least one rule indicates a frequency layer of the indicated at least one frequency layer for which additional measurement delays are allowed. In some embodiments, the radio interface is configured to transmit criteria to enable the WD to determine whether Doppler shift information for a neighbor cell of the indicated at least one neighbor cell fulfills the criteria. In some embodiments, the radio interface is configured to transmit criteria to enable the WD to determine whether Doppler shift information for a frequency layer of the indicated at least one frequency layer fulfills the criteria. In some embodiments, the radio interface is configured to transmit the Doppler shift information to the WD, the Doppler shift information being based at least in part on position information of at least one NTN node. In some embodiments, at least one of the indicated at least one neighbor cell and the indicated at least one frequency layer for which the measurement procedure is adapted are served by an NTN, node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example satellite network architecture;

FIG. 2 is an illustration of orbital elements;

FIG. 3 is an example of Doppler shift in an IoT NTN in downlink transmissions;

FIG. 4 is another example of Doppler shift in an IoT NTN in downlink transmissions;

FIG. 5 is a schematic diagram of an exemplary network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating exemplary methods implemented in a communication system including a host computer, a network node and a wireless device for executing a client application at a wireless device according to some embodiments of the present disclosure;

FIG. 8 is a flowchart illustrating exemplary methods implemented in a communication system including a host computer, a network node and a wireless device for receiving user data at a wireless device according to some embodiments of the present disclosure;

FIG. 9 is a flowchart illustrating exemplary methods implemented in a communication system including a host computer, a network node and a wireless device for receiving user data from the wireless device at a host computer according to some embodiments of the present disclosure;

FIG. 10 is a flowchart illustrating exemplary methods implemented in a communication system including a host computer, a network node and a wireless device for receiving user data at a host computer according to some embodiments of the present disclosure;

FIG. 11 is a flowchart of an exemplary process in a network node for measurement and mobility procedures due to doppler issues in an Internet of things (IoT) non-terrestrial network (NTN).

FIG. 12 is a flowchart of an exemplary process in a wireless device for measurement and mobility procedures due to doppler issues in an Internet of things (IoT) non-terrestrial network (NTN).

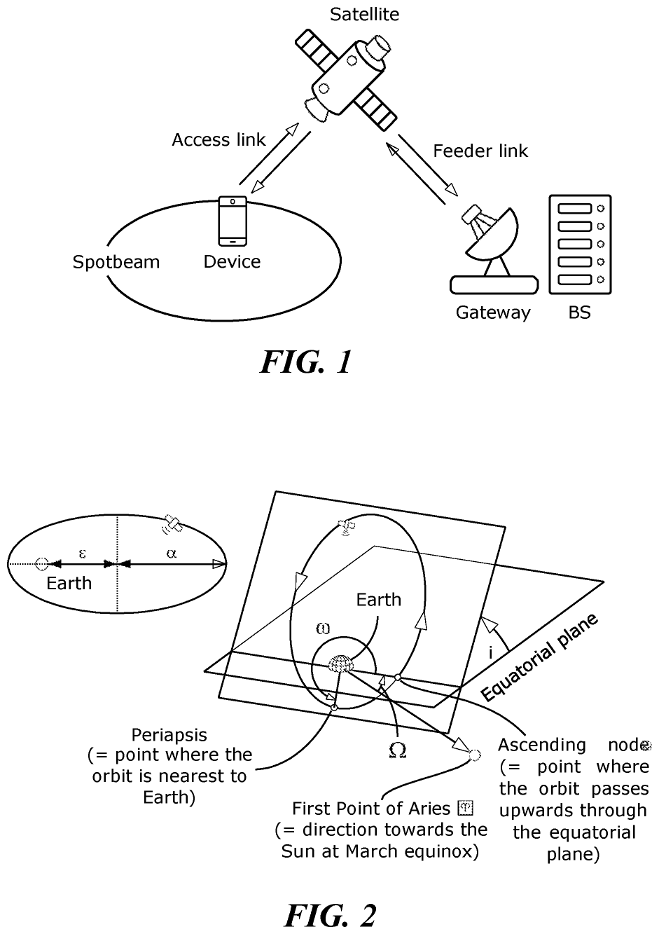

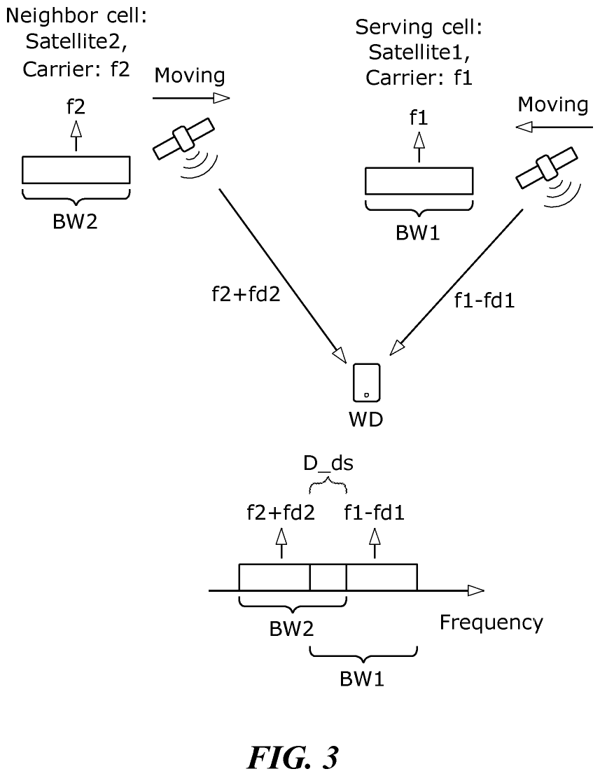

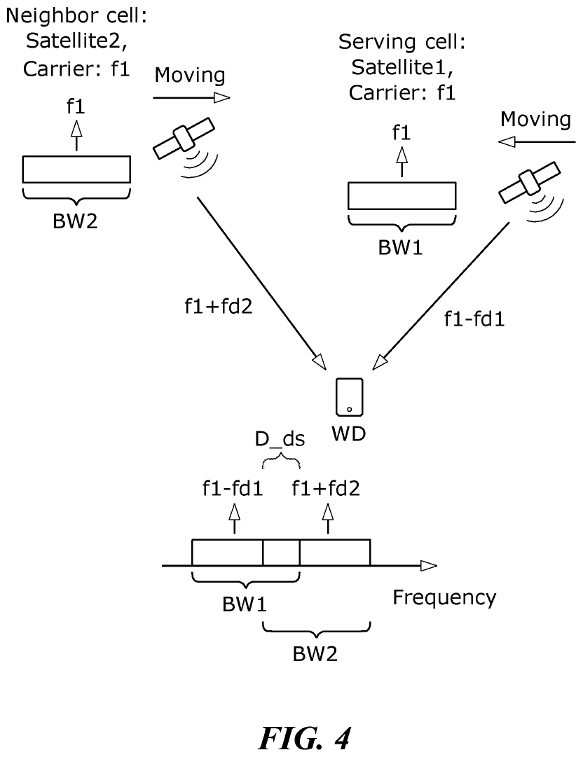

### DETAILED DESCRIPTION

Before describing in detail exemplary embodiments, it is noted that the embodiments reside primarily in combinations of apparatus components and processing steps related to measurement and mobility procedures due to doppler issues in an Internet of things (IoT) non-terrestrial network (NTN). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc. The term “WD” may also refer to any type of wireless device communicating with a network node and/or with another WD in a cellular or mobile communication system.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In this disclosure, the term “satellite” is used to include “radio network node (RN node) associated with a satellite”. The term RN node may refer to any type of radio node associated with a satellite. Examples of RN node are radio access network node, base station (BS), eNB, gNB etc. The term “satellite” may also be called a satellite node, satellite access node (SAN), a NTN node, high altitude platform (HAPS), node in earth atmosphere, node in the space etc. Here, the radio access node (e.g., eNB, gNB, BS etc.) associated with a satellite might include both a regenerative satellite, where the RN node (e.g., eNB, gNB, BS etc.) is the satellite payload, i.e., the RN node (e.g., eNB, gNB, BS etc.) is integrated with the satellite, or a transparent satellite, where the satellite payload is a relay and RN node (e.g., eNB, gNB, BS etc.) is on the ground (i.e., the satellite relays the communication between the RN node (e.g., eNB, gNB, BS etc.) on the ground and the WD).

A “coverage time”, “serving time”, “network availability”, “sojourn time” or “dwell time,” etc., is a time period or duration over which a WD may maintain connection, or may camp on, or may maintain communication, and so on to a satellite or a RN node (e.g., eNB, gNB, BS etc.) The term ‘Non-coverage time’, also known as “non-serving time” or “network unavailability”, or “non-sojourn time” or “non-dwell time” refers to a period of time during which a satellite or RN node (e.g., eNB, gNB, BS etc.) cannot serve or communicate or provide coverage to a WD. Another way to interpret the availability is that the WD may not need to measure a cell that is not likely to be serving cell (satellite via which serving cell is broadcasted). In this case, the terminology may still be the same as the no-coverage case or it may be different, e.g., “no need to measure”.

The term “node” may refer to a network node or a user equipment (UE). Examples of network nodes are NodeB, base station (BS), multi-standard radio (MSR) radio node such as multi-standard radio (MSR) base station (BS), eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, transmission reception point (TRP), remote radio unit (RRU), remote radio head (RRH), nodes in a distributed antenna system (DAS), core network node (e.g., mobile switching center (MSC), mobile management entity (MME), etc.), operations and maintenance (O&M), operation support system (OSS), self-organizing network (SON), positioning node (e.g., E-serving mobile location center (SMLC)), etc.

The term radio access technology, or RAT, may refer to any RAT e.g., UTRA, E-UTRA, narrow band internet of things (NB-IoT), Wi-Fi, Bluetooth, next generation RAT, New Radio (NR), 4G, 5G, NR NTN, IoT NTN, LTE NTN, 6G etc. Any of the equipment denoted by the term node, network node or radio network node may be capable of supporting a single or multiple RATs.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide measurement and mobility procedures due to doppler issues in an Internet of things (IoT) non-terrestrial network (NTN).

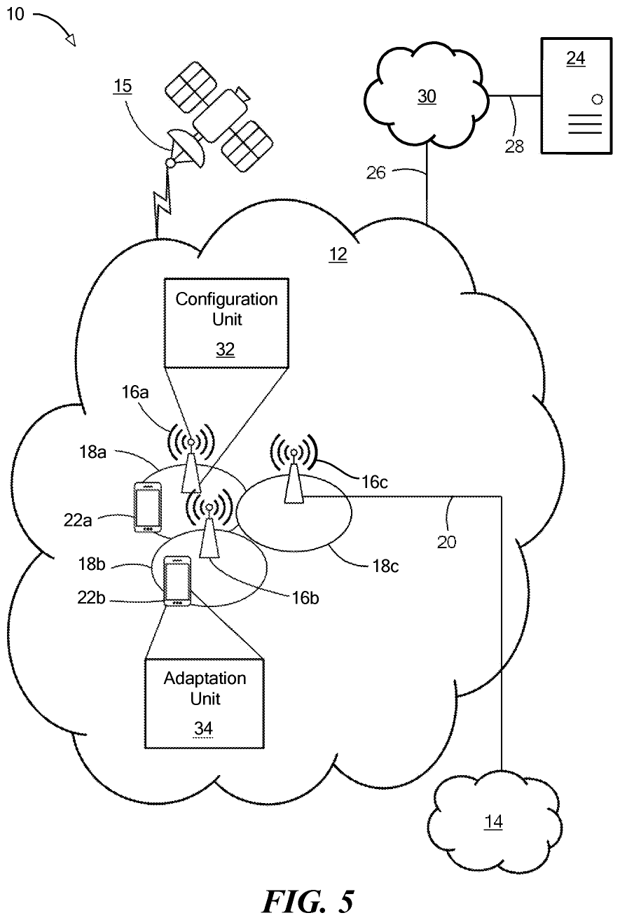

Returning now to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The communication system 10 includes one or more satellites 15 in communication with a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. The satellite(s) 15 and the network nodes 16 may communicate with a first wireless device (WD) 22a located in coverage area 18a. The WD 22a is configured to wirelessly connect to, or be paged by, the corresponding network node 16a and/or satellite(s) 15. A second WD 22b in coverage area 18b is wirelessly connectable to the corresponding network node 16b and/or satellite(s) 15. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which may be configured to configure the WD 22 to adapt the measurement procedure performed by the WD 22. A wireless device 22 is configured to include an adaptation unit 34 which may be configured to adapt a measurement procedure for the at least one neighbor cell and the at least one frequency layer.

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which may be configured to configure the WD 22 to adapt the measurement procedure performed by the WD 22.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an adaptation unit 34 which may be configured to adapt a measurement procedure for the at least one neighbor cell and the at least one frequency layer.

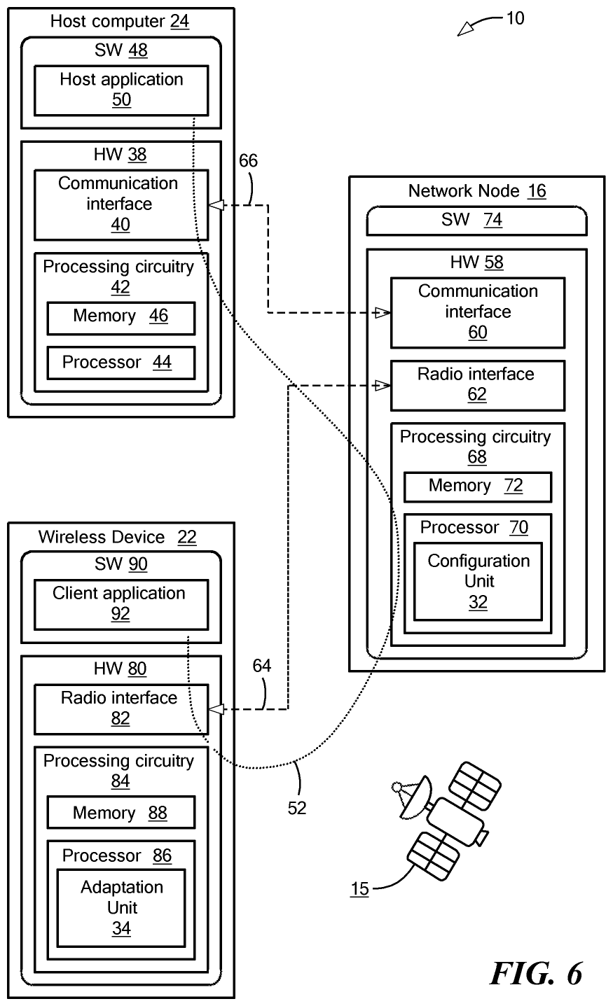

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as configuration unit 32, and adaptation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

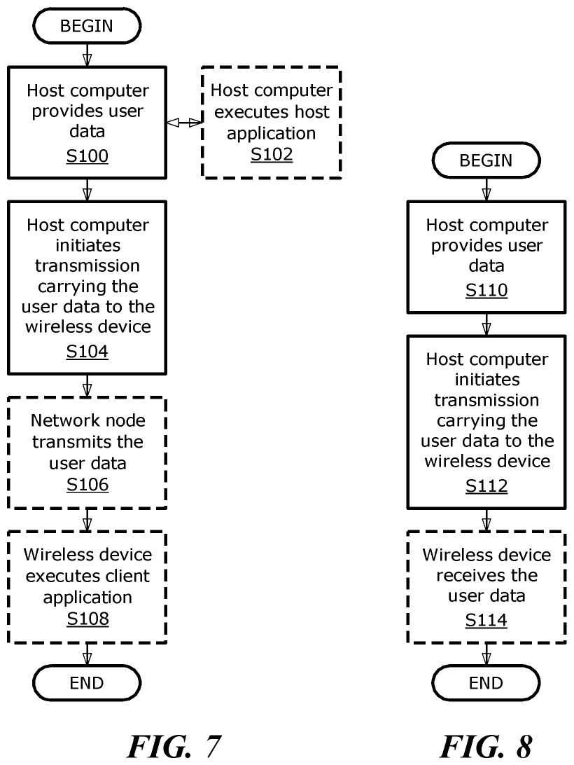

FIG. 7 is a flowchart illustrating an exemplary method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

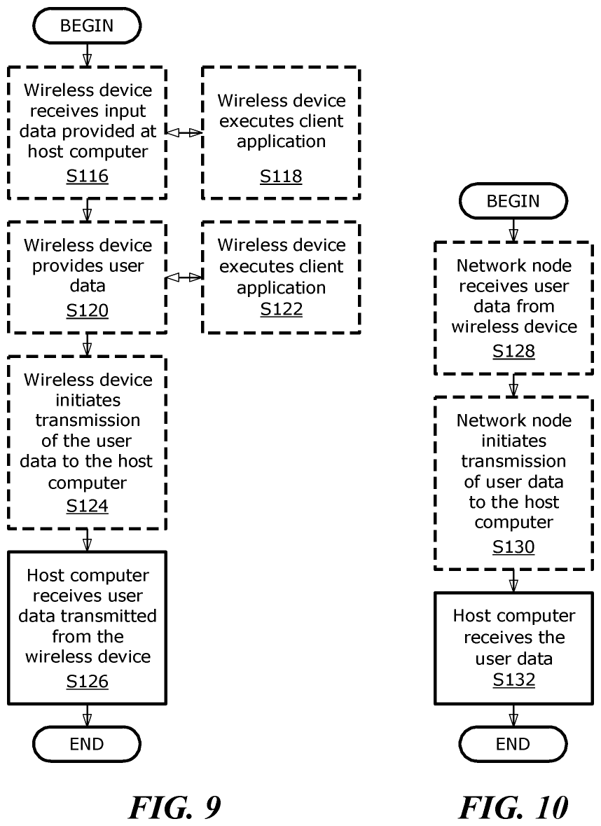

FIG. 9 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

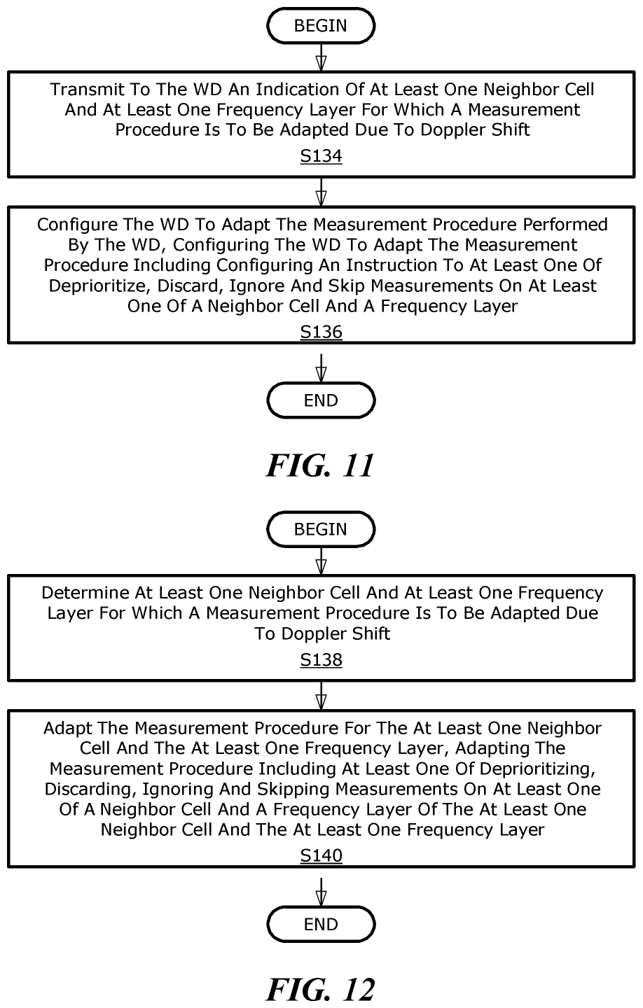

FIG. 11 is a flowchart of an exemplary process in a network node 16 for measurement and mobility procedures due to doppler issues in an Internet of things (IoT) non-terrestrial network (NTN). One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to transmit to the WD 22 an indication of at least one neighbor cell and at least one frequency layer for which a measurement procedure is to be adapted due to Doppler shift (Block S134). The process also includes configuring the WD 22 to adapt the measurement procedure performed by the WD 22. Configuring the WD 22 to adapt the measurement procedure includes configuring an instruction to at least one of deprioritize, discard, ignore and skip measurements on at least one of a neighbor cell of the indicated at least one neighbor cell and a frequency layer of the indicated at least one frequency layer (Block S136).

In some embodiments, the measurement procedure is adapted according to at least one rule that is predefined or configured by the network node. In some embodiments, the at least one rule indicates a neighbor cell of the indicated at least one neighbor cell for which a measurement is to be deprioritized, discarded, ignored or skipped. In some embodiments, the at least one rule indicates a frequency layer of the indicated at least one frequency layer for which a measurement is to be deprioritized, discarded, ignored or skipped. In some embodiments, the at least one rule indicates a neighbor cell of the indicated at least one neighbor cell for which additional measurement delays are allowed. In some embodiments, the at least one rule indicates a frequency layer of the indicated at least one frequency layer for which additional measurement delays are allowed. In some embodiments, the method includes transmitting criteria to enable the WD 22 to determine whether Doppler shift information for a neighbor cell of the indicated at least one neighbor cell fulfills the criteria. In some embodiments, the method includes transmitting criteria to enable the WD 22 to determine whether Doppler shift information for a frequency layer of the indicated at least one frequency layer fulfills the criteria. In some embodiments, the method includes transmitting the Doppler shift information to the WD 22, the Doppler shift information being based at least in part on position information of at least one NTN node. In some embodiments, at least one of the indicated at least one neighbor cell and the indicated at least one frequency layer for which the measurement procedure is adapted are served by an NTN, node.

FIG. 12 is a flowchart of an exemplary process in a wireless device 22 according to some embodiments of the present disclosure. One or more blocks described herein may be performed by one or more elements of wireless device 22 such as by one or more of processing circuitry 84 (including the adaptation unit 34), processor 86, radio interface 82 and/or communication interface 60. Wireless device 22 such as via processing circuitry 84 and/or processor 86 and/or radio interface 82 is configured to determine at least one neighbor cell and at least one frequency layer for which a measurement procedure is to be adapted due to Doppler shift (Block S138). The method includes adapting the measurement procedure for the at least one neighbor cell and the at least one frequency layer (Block S140). Adapting the measurement procedure includes at least one of deprioritizing, discarding, ignoring and skipping measurements on at least one of a neighbor cell of the determined at least one neighbor cell and a frequency layer of the determined at least one frequency layer.

In some embodiments, the measurement procedure is adapted according to at least one rule that is predefined or configured by the network node. In some embodiments, the at least one rule indicates the neighbor cell of the determined at least one neighbor cell for which a measurement is to be deprioritized, discarded, ignored or skipped. In some embodiments, the at least one rule indicates a frequency layer of the determined at least one frequency layer for which a measurement is to be deprioritized, discarded, ignored or skipped. In some embodiments, the at least one rule indicates a neighbor cell of the determined at least one neighbor cell for which additional measurement delays are allowed. In some embodiments, the at least one rule indicates a frequency layer of the determined at least one frequency layer for which additional measurement delays are allowed. In some embodiments, adapting the measurement procedure is based at least in part on whether Doppler shift information for a neighbor cell of the determined at least one neighbor cell fulfills criteria that is predefined or configured by the network node. In some embodiments, adapting the measurement procedure is based at least in part on whether Doppler shift information for a frequency layer of the determined at least one frequency layer fulfills criteria that is predefined or configured by the network node. In some embodiments, the method includes determining the Doppler shift information at the WD 22 based at least in part on position information of at least one NTN node. In some embodiments, at least one of the determined at least one neighbor cell and the determined at least one frequency layer for which the measurement procedure is adapted are served by an NTN, node.

Having described the general process flow of arrangements of the disclosure and having provided examples of hardware and software arrangements for implementing the processes and functions of the disclosure, the sections below provide details and examples of arrangements for measurement and mobility procedures due to doppler issues in an Internet of things (IoT) non-terrestrial network (NTN).

### EMBODIMENTS

### Scenarios and Definitions

### Doppler Shift Information (DSI):

In this disclosure, for embodiments on measurements and cell changes, the network node or the WD 22 may acquire Doppler shift information, i.e., DSI, on the basis of valid position information of satellites and the WD 22, e.g., ephemeris data of satellites and GNSS position of the WD 22. The DSI may include, for example:
D_ds: the collision range defined as at least a partial overlap in the frequency domain between the carrier frequency of a serving cell and at least one carrier frequency of one or more neighbor cells or between carrier frequencies of neighbor cells due to Doppler shift. It may be noted that the collision range may be represented by an offset between carriers, distance between closest boundaries of carriers in the frequency domain, etc., to indicate carriers overlapping each other in the frequency domain. As a general rule, the collision range may be expressed by the following function:

$$D\_ds = f ( BW 1 , BW 2 , f 1 , f 2 , fd 1 , fd 2 , k 1 , k 2 ) ,$$

k1 is a scaling factor associated with a first carrier or parameters associated with the first carrier e.g., BW1, f1, fd1, etc.;
k2 is a scaling factor associated with a second carrier or parameters associated with the second carrier e.g., BW2, f2, fd2, etc.;
Examples of functions are: sum, difference, maximum, minimum, product, ratio, average, xth percentile, ceiling, floor etc., or combination of two or more functions;
In one example:

$$D\_ds = ( ( B W 1 + BW 2 ) / 2 - ( f 1 - fd 1 ) - ( f 2 + f d 2 ) )$$

In another example, D_ds is not an explicit collision range, but instead is an indication indicating collision range, e.g., greater than threshold (H5), or greater than threshold (H5) and smaller than threshold (H6);
T1: Starting time of collision between carrier of serving cell and carriers of neighbor cells or among carriers of neighbor cells due to Doppler shift;
T2: Ending time of collision between carrier of serving cell and carriers of neighbor cells or among carriers of neighbor cells due to Doppler shift. T2 also may be termed as (T1+duration time of collision(T_ds):
   Where, T1, T2 may be acquired and assessed by the network node or the WD 22 with regard to position information of satellites and the WD 22 or pre-defined or configured by the network node. One example of format of T1 and T2 is absolute time, another example of T1 and T2 are relative time to a common base;
P_ds: Power level of Doppler shifted signal, P_ds may be based on measurement or pathloss estimation associated with positions of satellites and the WD 22.

### DSI Limitation Criteria (DSILC):

In one example, Doppler shift information, e.g., D_ds, T1, T2 and P_ds, is per satellite or per cell of neighbor cells and implies that each satellite or cell is associated with dedicated Doppler shift information.

In another example, Doppler shift information, e.g., D_ds, T1, T2 and P_ds, is per frequency or frequency layer of neighbor cells and implies that each frequency or frequency layer is associated with frequency dedicated Doppler shift information.

In another example, Doppler shift information, e.g., D_ds, T1, T2 and P_ds, corresponds to serving satellite or cell perspective. It implies that DSI only reflects the impact of the serving satellite or cell but cannot identify characteristics of neighbor cells.

Given that, set(s) of criteria to evaluate the impact of DSI is defined and referred to as DSI impact criteria (DSILC). In some embodiments, DSILC is fulfilled when one or more of the following conditions are met:
D_ds>TH_D1;
D_ds>TH_D1 and (T2−T1)>certain threshold;
P_ds>TH_P1;
P_ds>TH_P1 and (T2-T1)>certain threshold;
D_ds>TH_D1 and P_ds>TH_P1;
D_ds>TH_D1 and P_ds>TH_P1 and (T2−T1)>certain threshold
   where, TH_D1, TH_P1 may be pre-defined or configured by network node.

Furthermore, DSILC may include time information to indicate when impact of Doppler shift starts or end.

In one example, DSILC is fulfilled if T1<current time instance<T2, where:
T1 is the time instance when D_ds>TH_D1; and
T2 is the time instance when D_ds≤TH_D1;
   Or;
T1 is the time instance when P_ds>TH_P1; and
T2 is the time instance when P_ds≤TH_P1;
   Or;
T1 is the time instance when D_ds>TH_D1 and P_ds>TH_P1; and
T2 is the time instance when D_ds≤TH_D1 and P_ds≤TH_P1.

### Acquiring DSI:

In embodiments, the network node acquires Doppler shift information (DSI, e.g., including frequency range of collision between carrier of serving cell and carriers of neighbor cells or among carriers of neighbor cells due to Doppler shift, starting time, ending time and duration time of collision due to Doppler shift, estimated interference signal power level or ratio between wanted signal level and interference signal power level due to Doppler shift and so on) on the basis of position information of satellites and the WD 22, e.g., ephemeris data of satellites and GNSS position of the WD 22.

Alternatively, in embodiments, DSI is estimated and determined by the WD 22, and the WD 22 may report it to the network node by signaling containing the estimated DSI or signaling comprising an indication identifying the estimated DSI (e.g., to reduce signaling overheads). Determining the WD's capacity and DSI may be optional.

### WDs Reporting on DSI.

In case the DSI is estimated and determined by the WD 22 and the WD 22 is able to acquire valid position information of satellites and the WD 22, the WD 22 may report DSI to the network node by signaling containing the estimated DSI or the signaling may include an indication identifying the estimated DSI (e.g., to reduce signaling overheads). Examples of the DSI (the latter type of signaling) may include:
An indication indicating whether the WD 22 has estimated, encountered or experienced Doppler shift, e.g., 1 bit (yes/no) indication;
An indication indicating whether the wanted signal's frequency range impacted by Doppler is above certain threshold (H1) e.g., above H1 Hz;
An indication indicating whether the wanted signal's frequency range impacted by Doppler is below certain threshold (H2) e.g., below H2 Hz;
An indication indicating whether the power level of Doppler shifted signal on wanted signal is above certain threshold (H3) e.g., above H3 dBm;
An indication indicating whether the power level of Doppler shifted signal on wanted signal is below certain threshold (H4) e.g., below H4 dBm;
An indication indicating whether the Doppler frequency on wanted signal's frequency range is within a set of thresholds (H5 and H6) e.g., within H5 Hz and H6 Hz;
An indication indicating whether the Doppler frequency on wanted signal's frequency range is outside a set of thresholds (H7 and H8) e.g., outside or not within H5 Hz and H6 Hz;
An indication indicating whether the power level of Doppler frequency on wanted signal's frequency range is within a set of thresholds (H9 and H10) e.g., within H9 Hz and H10 Hz;
An indication indicating whether the power level Doppler frequency on wanted signal's frequency range is outside a set of thresholds (H11 and H12) e.g., outside or not within H11 Hz and H12 Hz; and/or
An indication comprising an identifier (Doppler ID) of the Doppler shift estimated or acquired or experienced by the WD 22, where the DSI belongs to one of pre-defined ranges. In one example, Doppler #0 is reported if the estimated DSI is within a first range, Doppler #1 is reported if the estimated DSI n is within a second range, and so on.
   where, H1, H2, H3 and H4 may be pre-defined or configured by network node.

### 1^{st} Embodiment: Choice of Neighbor Cells for Reselection

In a first embodiment, measurements on neighbor cells including detection and measurements on intra-frequency cells and inter-frequency cells is adapted based on the Dopplers shift information.

With reference to chapter 4.2.2.3 in 3GPP TS 38.133, ver. 17.6.0:

The WD may be able to identify new intra-frequency cells and perform SS-reference signal received power (RSRP) and SS-reference signal received quality (RSRQ) measurements of the identified intra-frequency cells without an explicit intra-frequency neighbor list containing physical layer cell identities.

For an intra-frequency cell that has been already detected, but that has not been reselected to, the filtering may be such that the WD may be capable of evaluating that the intra-frequency cell has met reselection criterion defined in 3GPP TS 38.304 within Tevaluate,NR_Intra when Treselection=0 as specified in table 4.2.2.3-1 or table 4.2.2.3-2 And with reference to chapter 4.2.2.4 in 3GPP TS 38.133, ver. 17.6.0.

The WD may be able to identify new inter-frequency cells and perform SS-RSRP or SS-RSRQ measurements of identified inter-frequency cells if carrier frequency information is provided by the serving cell, even if no explicit neighbor list with physical layer cell identities is provided.

The WD may be able to evaluate whether a newly detectable inter-frequency cell meets the reselection criteria defined in 3GPP TS 38.304 ver. 17.6.0 within Kcarrier*Tdetect,NR_Inter if at least carrier frequency information is provided for inter-frequency neighbor cells by the serving cells when Treselection=0. provided that the reselection criteria is met by a margin of at least 5 dB in FR1 or 6.5 dB in FR2 for reselections based on ranking or 6 dB in FR1 or 7.5 dB in FR2 for SS-RSRP reselections based on absolute priorities or 4 dB in FR1 and 4 dB in FR2 for SS-RSRQ reselections based on absolute priorities

The parameter Kcarrier is the number of NR inter-frequency carriers indicated by the serving cell.

With respect to above quotes, the WD's behavior may be interpreted and generalized as follows:
Identification and measurements on neighbor cells may be performed by the WD 22 continuously without preclusion rules on any possible neighbor cells; and/or
To a neighbor cell, if the signal level or signal quality at the WD 22 is not qualified or is not a best one among all neighbor cells, reselection to the neighbor may not happen even if it is detected.

It may make sense not to detect and measure the neighboring cell facing poor signal quality, which is not the target of cell reselection with support of associated information. In this manner, detection and measurements on neighbor cells may preclude those cells when DSI fulfills one or more criteria.

In one example, to a neighbor cell, taking DSI into account, if DSI on the neighbor cell fulfills DSILC, the WD 22 doesn't perform detection and measurements on the cell at least from T1.

One rule may be expressed as: the WD 22 may not consider an NR neighbor cell in cell reselection (it may be interpreted that the WD 22 doesn't detect, search, measure or choose the neighbor cell or perform other operations to ignore or skip the neighbor cell in reselection) at least from T1, if it is indicated that DSI fulfills DSILC.

The detections and measurements impacted by Doppler information depends on the timing of the appearance and disappearance of a collision. Some examples of the timing relationship may include:
In one example, the WD 22 may not consider a NR neighbor cell in cell reselection during explicit time period [T1, T2] provided the NR neighbor cell is indicated that DSI fulfills DSILC;
In another example, no explicit T1 and T2 are available. Instead starting and ending time relies on other implicit timing information. Once position information of the network or the WD 22 is updated, e.g., an update of SIB containing ephemeris data of satellites for the serving cell and neighbor cells, DSILC may be evaluated again and detection and measurements are performed depending on whether DSILC is fulfilled;
   This example may be interpreted that the WD 22 may not consider a NR neighbor cell in cell reselection provided the NR neighbor cell is indicated as DSI fulfilling DSILC in each updated valid time period of ephemeris data before expiry;
In another example, there is no explicit T1, T2 information. Once there is the risk of DSI fulfilling DSILC, which may be determined by the network node or the WD 22, the measurements on the cell may be precluded before RRC reconfiguration, i.e., semi-statically;
   In some embodiments, longer detections and measurements on neighbor cells are allowed provided DSILC is fulfilled;
In one example on neighbor cells, if DSI on the neighbor cell fulfills DSILC, longer detection and measurements on the cell are allowed at least during [T1, T2];
In another example on neighbor cells, if DSI on the frequency layer in any neighbor cell fulfills DSILC, longer measurements on cells with the frequency layer are allowed at least during [T1, T2]:
   In one example, as a reference, legacy measurement delays for inter-frequency NR cells in are captured in Table 2 below:

TABLE 2
T_{detect, NR}_{_{—}}_{Inter}, T_{measure, NR}_{_{—}}_{Inter} and T_{evaluate, NR}_{_{—}}_{Inter}

| DRX | | | | | |
|---|---|---|---|---|---|
| cycle | Scaling Factor | | T_{detect, NR}_{_{—}}_{Inter} | T_{measure, NR}_{_{—}}_{Inter} | T_{evaluate, NR}_{_{—}}_{Inter} |
| length | (N1) | | [s] (number of | [s] (number of | [s] (number of |
| [s] | FR1 | FR2^{Note1} | DRX cycles) | DRX cycles) | DRX cycles) |
| 0.32 | 1 | 8 | 11.52 × N1 × | 1.28 × N1 × 1.5 | 5.12 × N1 × 1.5 |
| | | | 1.5 (36 × N1 × 1.5) | (4 × N1 × 1.5) | (16 × N1 × 1.5) |
| 0.64 | | 5 | 17.92 × N1 | 1.28 × N1 | 5.12 × N1 |
| | | | (28 × N1) | (2 × N1) | (8 × N1) |
| 1.28 | | 4 | 32 × N1 | 1.28 × N1 | 6.4 × N1 |
| | | | (25 × N1) | (1 × N1) | (5 × N1) |
| 2.56 | | 3 | 58.88 × N1 | 2.56 × N1 | 7.68 × N1 |
| | | | (23 × N1) | (1 × N1) | (3 × N1) |

^{Note1}
Applies for WD supporting power class 2&3&4. For WD supporting power class 1 or 5, N1 = 8 for all DRX cycle length.

According to the above rules, in one example, as shown in Table 3 below, measurement delays for inter-frequency NR cells may be updated with more samples when DSI fulfills DSIL,C, where N2 is a scaling factor when DSI fulfills DSIL,C. N2 may be 1, 2 or 3, for example.

TABLE 3
T_{detect, NR}_{_{—}}_{Inter}, T_{measure, NR}_{_{—}}_{Inter} and T_{evaluate, NR}_{_{—}}_{Inter} when DSI fulfills criteria

| DRX | | | | | |
|---|---|---|---|---|---|
| cycle | Scaling Factor | | T_{detect, NR}_{_{—}}_{Inter} | T_{measure, NR}_{_{—}}_{Inter} | T_{evaluate, NR}_{_{—}}_{Inter} |
| length | (N1) | | [s] (number of | [s] (number of | [s] (number of |
| [s] | FR1 | FR2^{Note1} | DRX cycles) | DRX cycles) | DRX cycles) |
| 0.32 | 1 | 8 | 11.52 × N2 × N1 × | 1.28 × N2 × N1 × | 5.12 × N2 × N1 × |
| | | | 1.5 (36 × N2 × | 1.5 (4 × N2 × | 1.5 (16 × N2 × |
| | | | N1 × 1.5) | N1 × 1.5) | N1 × 1.5) |
| 0.64 | | 5 | 17.92 × N2 × N1 | 1.28 × N2 × N1 | 5.12 × N2 × N1 |
| | | | (28 × N2 × N1) | (2 × N2 × N1) | (8 × N2 × N1) |
| 1.28 | | 4 | 32 × N2 × N1 | 1.28 × N2 × N1 | 6.4 × N2 × N1 |
| | | | (25 × N2 × N1) | (1 × N2 × N1) | (5 × N2 × N1) |
| 2.56 | | 3 | 58.88 × N2 × N1 | 2.56 × N2 × N1 | 7.68 × N2 × N1 |
| | | | (23 × N2 × N1) | (1 × N2 × N1) | (3 × N1) |

^{Note1}
Applies for WD supporting power class 2&3&4. For WD supporting power class 1 or 5, N1 = 8 for all DRX cycle length.

Another example of the rule of measurements on inter-frequency NR cells may be expressed as: measurements on inter-frequency cells are expected to be longer than Table 2 if it is indicated that DSI fulfills DSTL,C.

Another aspect of the embodiment is that number of simultaneous measurements on serving cell/satellites and neighbor cells/satellites are restricted provided DSIL,C is fulfilled.
In one example on neighbor cells, if DSI on the neighbor cell/satellite fulfills or has risk to fulfill DSTL,C, simultaneous measurements on only one neighbor cells/satellites may be assumed by the WD 22 at least during [T1, T2], or semi-statically or statically. One consequence is longer measurements on neighbor cells. In some embodiments, simultaneous measurements on only one neighbor cell/satellites may be assumed by the WD 22 in IoT NTN;
In another example on neighbor cells, if DSI on the neighbor cell/satellite fulfills or has risk to fulfill DSILC, simultaneous measurements on only one cells/satellites out of serving cell/satellite and neighbor cells/satellites may be assumed by the WD 22 at least during [T1, T2] or semi-statically or statically. One consequence is longer measurements on serving cell and neighbor cells and measurement sharing between them. A particular example is simultaneous measurements on only one cell/satellite out of serving cell/satellite and neighbor cells/satellites may be assumed by the WD 22 in IoT NTN.

In some embodiments, DSI and DSILC and their relationship to reselection and neighbor cell search, detection and measurements for the reselection, may be applied to other cell mobility procedures or cell change, e.g., handover, cell selection, cell reselection, RRC connection release with redirection, RRC connection re-establishment, conditional handover, etc.

### 2^{nd} Embodiment: Criteria to Start Neighbor Cell Search

In a second embodiment, the criteria of the WD 22 starting to search neighbor cells for cell reselection and subsequently perform cell reselection is adapted based on the determined Doppler shift information.

With reference to chapter 4.2.2.4 in 3GPP TS 38.133, ver. 17.6.0, where searching for neighbor cells depends on Srxlev and/or Squal.

If Srxlev>SnonIntraSearchP and Squal>SnonIntraSearchQ then the WD may search for inter-frequency layers of higher priority at least every Thigher_priority_search where Thigher_priority_search is described in clause 4.2.2.7. If Srxlev≤SnonIntraSearchP or Squal≤SnonIntraSearchQ then the WD may search for and measure inter-frequency layers of higher, equal or lower priority in preparation for possible reselection.

Taking Doppler shift into account, the one or more criteria for starting to search neighbor cells is impacted. For example, if it is known that performance degradation on the serving cell due to Doppler shift is occurring or will occur, the WD 22 may start search inter-frequency layers of higher priority or search for and measure inter-frequency layers of higher, equal or lower priority in preparation for possible reselection.
In one example on the serving cell, if DSI on the serving cell fulfills DSILC, the WD 22 may initialize searching inter-frequency layers of higher priority or searching for and measuring inter-frequency layers of higher, equal or lower priority in preparation for possible reselection at least before T1;
In another example on serving cell, if DSI on the serving cell fulfills DSILC and Srxlev Squal fulfill legacy corresponding criteria, the WD 22 may initialize searching inter-frequency layers of higher priority or searching for and measuring inter-frequency layers of higher, equal or lower priority in preparation for possible reselection at least before T1.

With reference to chapter 4.2.2.2 in 3GPP TS 38.133, ver. 17.6.0, the WD 22 may start cell selection if failing to find suitable cells for a pre-defined time period.

If the WD in RRC_IDLE has not found any new suitable cell based on searches and measurements using the intra-frequency, inter-frequency and inter-RAT information indicated in the system information for 10 s, the WD may initiate cell selection procedures for the selected PLMN as defined in 3GPP TS 38.304.

In some embodiments, DSI may impact the WD's initial cell search procedure upon failing to find suitable cells during a pre-defined time period. In one example, if DSI fulfills DSILC from T1, the WD 22 may initiate cell selection procedures at T1 even before the pre-defined time period has not elapsed or exceeded, e.g. 10 s, for searches and measurements has not expired.

### 3^{rd} Embodiment: Conversion Between Intra-Frequency and Inter-Frequency Measurements

In a third embodiment, the one or more criteria to differentiate intra-frequency and inter-frequency measurements are changed or adapted based on the determined Doppler shift information.

Doppler shift introduces or causes frequency offset. Depending on the WD's capability, the WD 22 may need to retune its radio circuit to receive various Doppler shifted intra-frequency carriers, i.e., inter-frequency measurement procedure is applied.
In one example on at least an intra-frequency neighbor cell, if DSI on the neighbor cell(s) fulfills DSILC, intra-frequency measurement requirements do not apply on the neighbor cell(s) or there are no measurement requirements on the neighbor cell(s) at least in [T1, T2]. In this case, the WD 22 discards the measurements on those intra-frequency carriers;
In another example on at least an intra-frequency neighbor cell, if DSI on the neighbor cell(s) fulfills DSILC, the WD 22 may apply inter-frequency measurement procedure on the intra-frequency neighbor cell at least during [T1, T2]. This means the intra-frequency carriers are treated the same way as inter-frequency carriers and thus, the WD 22 may meet the requirements associated with the inter-frequency carriers. A particular example is that the number of measurements on inter-frequency cells may be Kcarrier (the number of NR inter-frequency carriers indicated by the serving cell)+K_{carrier_ds} (the number of Doppler shifted NR intra-frequency carriers). The value of K_{carrier_ds} depends on the DSI, e.g., value of D_ds and the WD's capability. In one example, a number of intra-frequency cells may be added to K_{carrier_ds}, provided the DSI on the intra-frequency cells fulfills DSILC.
In another example, a requirement for measurements on intra-frequency cells may be relaxed at least in [T1, T2]. For instance, the Table 4 below may be updated with more samples provided DSI on the intra-frequency cell fulfills DSILC.

TABLE 4
T_{detect, NR}_{_{—}}_{Intra}, T_{measure, NR}_{_{—}}_{Intra} and T_{evaluate, NR}_{_{—}}_{Intra}

| DRX | | | | | |
|---|---|---|---|---|---|
| cycle | Scaling | | T_{detect, NR}_{_{—}}_{Intra} | T_{measure, NR}_{_{—}}_{Intra} | T_{evaluate, NR}_{_{—}}_{Intra} |
| length | Factor (N1) | | [s] (number of | [s] (number of | [s] (number of |
| [s] | FR1 | FR2^{Note1} | DRX cycles) | DRX cycles) | DRX cycles) |
| 0.32 | 1 | 8 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | 5 | 17.92 × N1 | 1.28 × N1 | 5.12 × N1 |
| | | | (28 × N1) | (2 × N1) | (8 × N1) |
| 1.28 | | 4 | 32 × N1 | 1.28 × N1 | 6.4 × N1 |
| | | | (25 × N1) | (1 × N1) | (5 × N1) |
| 2.56 | | 3 | 58.88 × N1 | 2.56 × N1 | 7.68 × N1 |
| | | | (23 × N1) | (1 × N1) | (3 × N1) |

^{Note1}
Applies for WD supporting power class 2&3&4. For WD supporting power class 1 or 5, N1 = 8 for all DRX cycle length.
Note 2:
M2 = 1.5 if SMTC periodicity of measured intra-frequency cell >20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_{_{—}}ᵢₙₜᵣₐ is expected.

One example of update is shown in Table 5 below, where N4 is a scaling factor when DSI fulfills DSIL,C. N4 may be 1, 2 or 3 and so on, or N4 may be proportional to the number of intra-frequency cells which DSI fulfills DSTL,C.

TABLE 5
T_{detect, NR}_{_{—}}_{Intra}, T_{measure, NR}_{_{—}}_{Intra} and T_{evaluate, NR}_{_{—}}_{Intra} when DSI fulfills criteria

| DRX | | | | | |
|---|---|---|---|---|---|
| cycle | Scaling Factor | | T_{detect, NR}_{_{—}}_{Inter} | T_{measure, NR}_{_{—}}_{Inter} | T_{evaluate, NR}_{_{—}}_{Inter} |
| length | (N1) | | [s] (number of | [s] (number of | [s] (number of |
| [s] | FR1 | FR2^{Note1} | DRX cycles) | DRX cycles) | DRX cycles) |
| 0.32 | 1 | 8 | 11.52 × N4 × N1 × | 1.28 × N4 × N1 × | 5.12 × N4 × N1 × |
| | | | 1.5 (36 × N2 × | 1.5 (4 × N4 × | 1.5 (16 × N4 × |
| | | | N1 × 1.5) | N1 × 1.5) | N1 × 1.5) |
| 0.64 | | 5 | 17.92 × N4 × N1 | 1.28 × N4 × N1 | 5.12 × N4 × N1 |
| | | | (28 × N2 × N1) | (2 × N4 × N1) | (8 × N4 × N1) |
| 1.28 | | 4 | 32 × N4 × N1 | 1.28 × N4 × N1 | 6.4 × N4 × N1 |
| | | | (25 × N2 × N1) | (1 × N3 × N1) | (5 × N4 × N1) |
| 2.56 | | 3 | 58.88 × N4 × N1 | 2.56 × N4 × N1 | 7.68 × N4 × N1 |
| | | | (23 × N2 × N1) | (1 × N3 × N1) | (3 × N4 × N1) |

^{Note1}
Applies for WD supporting power class 2&3&4. For WD supporting power class 1 or 5, N1 = 8 for all discontinuous reception (DRX) cycle length.

Another example of the rule of measurements on intra-frequency NR cells may be expressed as: measurements on intra-frequency cells are expected to be longer than Table 4 if it is indicated that DSI fulfills DSILC.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G 5th Generation
BS Base Station
CHO Conditional Handover
eNB Evolved NodeB (LTE base station)
GEO Geostationary Orbit
gNB Base station in NR.
GNSS Global Navigation Satellite System
HO Handover
LEO Low Earth Orbit
LTE Long Term Evolution
MAC Medium Access Control
NR New Radio
NW Network
NTN Non-Terrestrial Network
RAT Radio Access Technology
RRC Radio Resource Control
RRM Radio Resource Management
RS Reference Signal
RSRP Reference Signal Received Power
SMTC SSB Measurement Timing Configuration
SNR Signal to noise ratio
UE User Equipment
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a wireless device, WD, configured to communicate with a network node in a non-terrestrial network, NTN, the method comprising:
determining at least one neighbor cell and at least one frequency layer for which a measurement procedure is to be adapted due to Doppler shift; and
adapting the measurement procedure for the at least one neighbor cell and the at least one frequency layer, adapting the measurement procedure including at least one of deprioritizing, discarding, ignoring and skipping measurements on at least one of a neighbor cell of the determined at least one neighbor cell and a frequency layer of the determined at least one frequency layer.

2. The method of claim 1, wherein the measurement procedure is adapted according to at least one rule that is predefined or configured by the network node.

3. The method of claim 2, wherein the at least one rule indicates the neighbor cell of the determined at least one neighbor cell for which a measurement is to be deprioritized, discarded, ignored or skipped.

4. The method of claim 2, wherein the at least one rule indicates a frequency layer of the determined at least one frequency layer for which a measurement is to be deprioritized, discarded, ignored or skipped.

5. The method of claim 2, wherein the at least one rule indicates a neighbor cell of the determined at least one neighbor cell for which additional measurement delays are allowed.

6. The method of claim 2, wherein the at least one rule indicates a frequency layer of the determined at least one frequency layer for which additional measurement delays are allowed.

7. The method of claim 1, wherein adapting the measurement procedure is based at least in part on whether Doppler shift information for a neighbor cell of the determined at least one neighbor cell fulfills criteria that is predefined or configured by the network node.

8. The method of claim 1, wherein adapting the measurement procedure is based at least in part on whether Doppler shift information for a frequency layer of the determined at least one frequency layer fulfills criteria that is predefined or configured by the network node.

9. The method of claim 7, further comprising determining the Doppler shift information at the WD based at least in part on position information of at least one NTN node.

10. The method of claim 1, wherein at least one of the determined at least one neighbor cell and the determined at least one frequency layer for which the measurement procedure is adapted are served by an NTN, node.

11. A wireless device, WD, configured to communicate with a network node in a non-terrestrial network, NTN, the WD comprising processing circuitry configured to:
determine at least one neighbor cell and at least one frequency layer for which a measurement procedure is to be adapted due to Doppler shift; and
adapt the measurement procedure for the at least one neighbor cell and the at least one frequency layer, adapting the measurement procedure including at least one of deprioritizing, discarding, ignoring and skipping measurements on at least one of a neighbor cell of the determined at least one neighbor cell and a frequency layer of the determined at least one frequency layer.

12-20. (canceled)

21. A method in a network node configured to communicate with a wireless device, WD, in a non-terrestrial network, NTN, the method comprising:
transmitting to the WD an indication of at least one neighbor cell and at least one frequency layer for which a measurement procedure is to be adapted due to Doppler shift; and
configuring the WD to adapt the measurement procedure performed by the WD, configuring the WD to adapt the measurement procedure including configuring an instruction to at least one of deprioritize, discard, ignore and skip measurements on at least one of a neighbor cell of the indicated at least one neighbor cell and a frequency layer of the indicated at least one frequency layer.

22. The method of claim 21, wherein the measurement procedure is adapted according to at least one rule that is predefined or configured by the network node (46).

23. The method of claim 22, wherein the at least one rule indicates a neighbor cell of the indicated at least one neighbor cell for which a measurement is to be deprioritized, discarded, ignored or skipped.

24. The method of claim 22, wherein the at least one rule indicates a frequency layer of the indicated at least one frequency layer for which a measurement is to be deprioritized, discarded, ignored or skipped.

25. The method of claim 22, wherein the at least one rule indicates a neighbor cell of the indicated at least one neighbor cell for which additional measurement delays are allowed.

26. The method of claim 22, wherein the at least one rule indicates a frequency layer of the indicated at least one frequency layer for which additional measurement delays are allowed.

27. The method of claim 21, further comprising transmitting criteria to enable the WD to determine whether Doppler shift information for a neighbor cell of the indicated at least one neighbor cell fulfills the criteria.

28. The method of claim 21, further comprising transmitting criteria to enable the WD to determine whether Doppler shift information for a frequency layer of the indicated at least one frequency layer fulfills the criteria.

29-30. (canceled)

31. A network node configured to communicate with a wireless device, WD, in a non-terrestrial network, NTN, the network node comprising:
a radio interface configured to transmit to the WD an indication of at least one neighbor cell and at least one frequency layer for which a measurement procedure is to be adapted due to Doppler shift; and
processing circuitry in communication with the radio interface and configured to configure the WD to adapt the measurement procedure performed by the WD, configuring the WD to adapt the measurement procedure including configuring an instruction to at least one of deprioritize, discard, ignore and skip measurements on at least one of a neighbor cell of the indicated at least one neighbor cell and a frequency layer of the indicated at least one frequency layer.

32-40. (canceled)
